(19) United States
(12) Patent Application Publication
(10) Pub. No.: US 2011/0143208 A1
(43) Pub. Date: Jun. 16, 2011

(54) Non-Aqueous Electrochemical Cell using Fluorinated Carbon-carbon Composite Electrode

(75) Inventors: Sohrab Hossain, Tucson, AZ (US); John Paul Ruiz, Azusa, CA (US)

(73) Assignee: Contour Energy Systems, Inc., Azusa, CA (US)

(21) Appl. No.: 12/964,693

(22) Filed: Dec. 9, 2010

Related U.S. Application Data
(60) Provisional application No. 61/285,892, filed on Dec. 11, 2009.

(51) Int. Cl. H01M 4/583; H01M 4/86

(52) U.S. Cl. 429/231.7; 252/182.1

(57) ABSTRACT

Non-aqueous electrochemical cells, and batteries formed of such cells are described. More particularly, use of electrochemical cells containing sub-fluorinated carbon-carbon composite as an active material for the positive electrode of such cells and batteries is disclosed. When used in conjunction with lithium anodes and a non-aqueous electrolyte, the electrochemical cell provides high discharge rate and excellent capacity utilization.

### RELATED APPLICATION

This application claims the benefit of U.S. Provisional Application No. 61/285,892, filed Dec. 11, 2009, the disclosure of which is incorporated by reference herein.

### FIELD OF THE INVENTION

Non-aqueous electrochemical cells, and batteries formed of such cells are described. More particularly, use of electrochemical cells containing sub-fluorinated carbon-carbon composite as an active material for the positive electrode of such cells and batteries is disclosed

### BACKGROUND AND SUMMARY

Fluorinated carbon (CFₓ) is used commercially as a positive electrode material for primary lithium batteries (Li/CFₓ). The specific capacity (mAh/g) of CFₓ increases with the fluorine content in the carbon structure and, therefore, CFₓ with x close to unity have been studied extensively for the development of high specific energy (Wh/kg) and high energy density (Wh/l) batteries. A simplified cell reaction is:

xLi+CFₓ→xLiF+C

Commercial Li/CFₓ cells contain LiBF₄ electrolyte in gamma-butyrolactone (GBL) or a mixture of propylene carbonate (PC) and dimethoxyethane (DME). Since CFₓ material is chemically stable in organic electrolytes and does not thermally decompose up to 400° C., Li/CFₓ cells offer long shelf life and can be operated in a wide temperature range.

The main disadvantage of conventional Li/CF_{X} cells is their poor performance at higher rate of discharge and, therefore, they are used in limited low drain applications.

CFₓ materials are commonly made by the reaction of carbon powder with fluorine or a mixture of fluorine and inert gas at around 500° C. with a residence time close to 72 hours. This high temperature reaction for a long period of time increases the cost of the CFₓ material. CFₓ can be made from various carbon precursors to have a powder or granular form can be used as a cathode material for non-aqueous electrochemical cells. For example, U.S. Pat. No. 3,536,532 (Watanabe et al) describes CFₓ material derived from crystalline carbon, U.S. Pat. No. 3,700,502 (Watanabe et al) describes amorphous or partially amorphous carbon, J. Power Sources, 153, 354-359 (2006) (Lam et al) describes sub-fluorinated graphite, Japanese patent publication 2005285440 describes multi-wall carbon nanotubes, Carbon, 35, 723 (1997) (Hamwi et al) describes carbon nanotubes, J. Fluorine Chem., 114,181-188 (2002) (Touhara et al) describes carbon nanotubes, U.S. Pat. No. 5,106,606 (Endo et al) describes graphite fiber, U.S. Pat. No. 6,841,610 (Yanagisawa et al.) describes carbon fiber precursors.

The electrical conductivity of CFₓ materials typically decreases with the increase of fluorine-content and becomes an insulator when x is equal to or greater than 1. When making a cathode, CFₓ can be mixed with carbon powder to improve the electrical conductivity and further mixed with PTFE or PVDF binder to improve the mechanical integrity of the electrode. The use of such electrochemically inactive materials, however, reduces the specific cathode capacity.

### BRIEF DESCRIPTION OF THE DRAWINGS

In the accompanying drawings:

FIG. 1A represents steps involved in making CFₓ electrodes with a carbon-carbon composite.

FIG. 1B is a prior art representation of steps involved in making CFₓ electrodes with a powder precursor material.

FIG. 2 shows two graphs representing the discharge behavior of two Li/CFCFₓ cells made with fluorinated carbon-carbon composite cathode of x values 0.31 and 0.78.

FIG. 3 represents the discharge behavior of a Li/CFₓ cell made with a CFₓ powder-based electrode.

FIG. 4 represents the discharge behavior at 4 mA/cm² current density of Li/CFₓ cells made with a carbon-carbon electrode and with a powder-based electrode.

FIG. 5 is a schematic representation of Li/CFₓ coin cell embodying a fluorinated carbon-carbon composite positive electrode.

### DETAILED DESCRIPTION

Fluorinated rigid or semi-rigid carbon-carbon composite materials can be used instead of electrodes based on loose, binder mixed powder. A sheet of rigid or semi-rigid carbon-carbon composite offers several advantages over CFₓ powder materials including (i) no necessity for handling of powder material, (ii) no requirement for mixing with solvent, binder, and carbon powder, (iii) up to 100% cathode active material, and a (iv) lower temperature and reaction time to fluorinate. Such carbon-carbon electrode, lithium-ion electrochemical cells that use lithiated metal oxide intercalation compounds (for example, lithium cobalt oxide) are generally described in U.S. Pat. No. 6,436,576 (Hossain). In contrast to prior art disclosures where CFₓ powder electrochemical systems are utilized, this disclosure includes an electrochemical cell with a body of non-aqueous electrolyte, first and second electrodes in effective contact with said electrolyte, the first electrode comprising alkali metal such as lithium and the second electrode comprising sub-fluorinated carbon-carbon composite. Such sub-fluorinated carbon-carbon composite materials provide high electrical conductivity and are used as the positive electrode of the electrochemical cell. As compared to powder-based electrodes made with either sub-fluorinated CFₓ, or fully fluorinated CF₁ or (CF₂)ₙ, the rate capability of the Li/CFₓ cells made with the sub-fluorinated carbon-carbon composite electrode shows significant improvement.

In certain embodiments, the fluorinated carbon-carbon composite electrode does not contain any binder or electrical diluents (carbon powder). The practical delivered specific capacity of the composite electrode is significantly higher than the electrode made with powder-based CFₓ material of same x value.

In one embodiment, a Li/CFₓ cell includes a positive electrode of fluorinated carbon-carbon composite material and a negative electrode of metallic lithium. The electrolyte used in a Li/CFₓ cell and battery is a non-aqueous organic electrolyte and preferably a non-aqueous solution consisting of a solute, such as LiBF₄, LiPF₆, LiCF₃SO₃, LiN(CF₃SO₂)₂, LiAsF₆, or LiClO₄, dissolved in a solvent such as gamma-butyrolactone, propylene carbonate, dimethoxyethane, ethylene carbonate, diethyl carbonate, dimethyl carbonate, ethyl methyl carbonate and as well as mixtures thereof.

There are a number of known approaches suitable for producing carbon-carbon composite materials, which are described, for example in the following review books: Essentials of Carbon-Carbon Composites, edited by C. R. Thomas, The Royal Society of Chemistry, Cambridge, 1993 and Carbon-Carbon Composites, by G. Savage, Chapman and Hall, New York, 1993. Carbon-carbon composite is generally defined to be a carbon fiber-reinforced carbon matrix material. The carbon matrix phase is typically formed by solid, liquid or gaseous pyrolysis of an organic precursor material. The matrix is either a graphitizable carbon or non-graphitizable carbon, and the carbonaceous reinforcement is fibrous in form. The composite may also contain other components in particulate or fibrous forms (IUPAC Compendium of Chemical Terminology 2nd Edition (1997). A suitable carbon-carbon composite is made by heat treating at the temperature range of 1000-3000° C. in inert atmosphere and can have density, specific resistance, and thermal conductivity in the range of 1.2-2.0 g/cc, 50-1,000 microOhm-cm, 50-600 Wm⁻¹K⁻¹, respectively. The carbon fiber used to make the carbon-carbon composite can be pitch-, polyacrylonitrile (PAN)-, and/or rayon-based fiber. Other than the foregoing general parameters, no specific approach to produce carbon-carbon composite is required.

Sub-fluorination of a carbon-carbon composite sheet is done in a reactor by passing fluorine gas or a mixture of fluorine and other inert gas at a temperature in the range of 250-450° C. for a period of time depending upon the level of fluorination (x value in CF_{X}). The level of sub-fluorination of carbon-carbon composite in this invention can be in the range of x=0.30 to x=0.99, and when processing time is restricted, commonly in the range x=0.6 to x=0.85. In certain embodiments, fully fluorinated CFₓ (x=1.0, CF) or super-fluorinated (x>1.0) can form at least a portion of carbon-carbon composite, providing a CFCF_{X} composite.

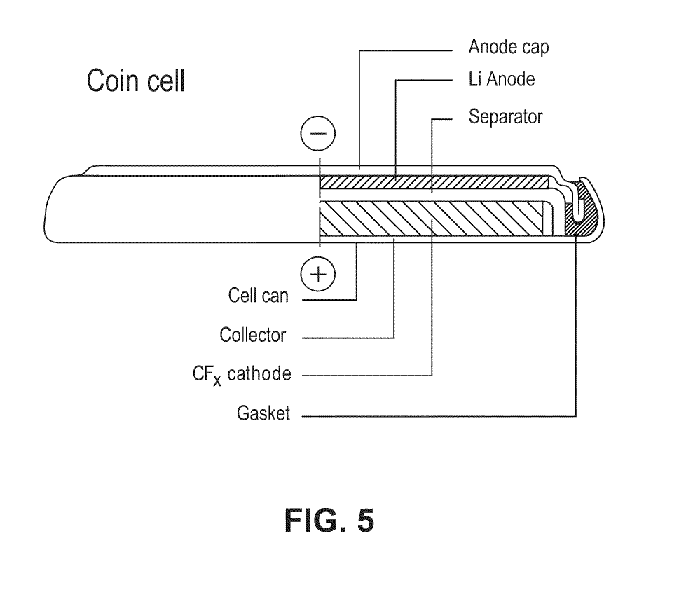

A preferred form of Li/CFCFₓ cell embodying a fluorinated carbon-carbon composite cathode is shown in FIG. 5. Wherein the assembled cell is shown with the anode, cathode, separator, and electrolyte enclosed in a coin cell structure. The anode and cathode of the assembled cell are separated by a porous separator that is permeated with a non-aqueous electrolyte (not shown) that is in effective contact with both the anode and cathode.

The following specific examples are given to illustrate certain embodiments, the practice of the invention, but are not to be considered as limiting in any way.

### EXAMPLE 1

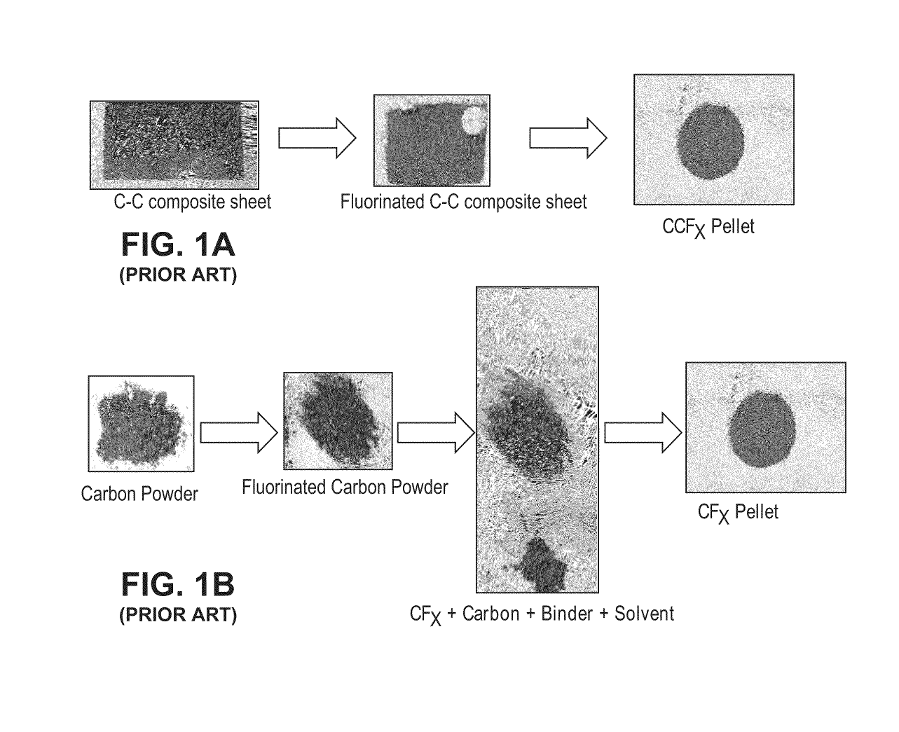

FIGS. 1A and 1B shows the differences between the steps involved in making electrodes using carbon-carbon composite and powder carbon materials. A carbon-carbon composite sheet is used as precursor material which is reacted with fluorine to obtain different level of fluorinated carbon-carbon composite sheet. The CFₓ cathode can be obtained by stamping out from the composite sheet.

In comparison, carbon powder is used as precursor which is fluorinated and the resulting CFₓ powder material is then mixed with binder and electrical conductor to make CFₓ electrodes.

### EXAMPLE 2

Two samples of fluorinated carbon-carbon composite sheets of fluorination level x=0.3 and x=0.76 were used to fabricate Li/CFCFx 2016 coin cells. The form factor of the Li/CFCFₓ cells was 2016 coin cell which included a metallic lithium anode, fluorinated carbon-carbon composite cathode and 1M LiBF4 electrolyte in a mixture (1:1 v/v) of propylene carbonate and dimethoxyethane. The cells are made cathode limited. A non-woven fiber glass separator was used in between the positive and negative electrode to isolate them electrically. The non-aqueous electrolyte permeated the separator, whereby the electrolyte was in effective contact with both the positive and negative electrodes, which were nevertheless maintained space and electrically isolated from one another.

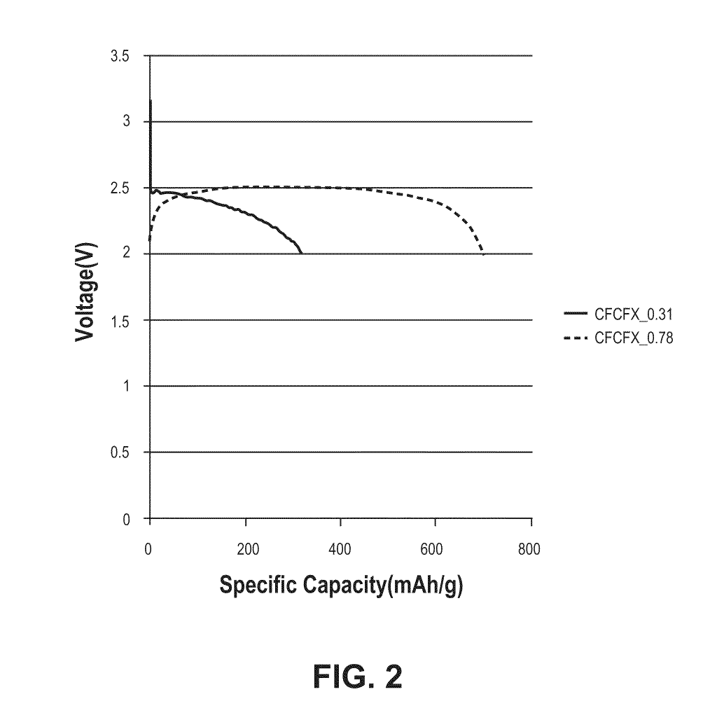

The cells were tested at 1 mA discharge rate. FIG. 2 shows the discharge behavior of the two cells and illustrates how the level of fluorination affects the delivered specific capacity (mAh/g). The cell made with the cathode of lower level of fluorination (x=0.3) shows higher operating voltage but significantly lower delivered capacity, as expected.

The cell made with the cathode of higher level of fluorination (x=0.76) delivers over 93% of theoretical capacity of the cathode.

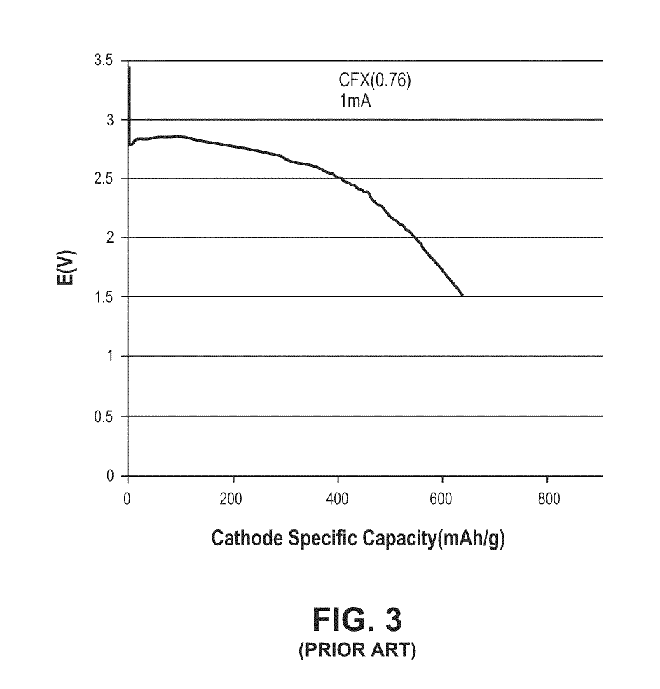

A Li/CFₓ 2016 coin cell was made with the same components as described above except the positive electrode was made from a mixture of 85% fluorinated (x=0.76) carbon powder, 8% PVDF binder, and 7% carbon black. This cell was discharged under the same condition (1 mA) as the previous cells. FIG. 3 shows the discharge behavior of this prior art cell. The cell delivered only 82% of theoretical capacity of the fluorinated carbon powder cathode.

### EXAMPLE 3

A Li/CFCFₓ coin cell was made as in example 2 with fluorinated (x=0.76) carbon-carbon composite cathode, lithium metal anode and an electrolyte comprising 1M LiBF₄ in gamma-butyrolactone organic solvent. The cell was discharged at 4 mA/cm² to a cut-off voltage of 2.0 V.

A Li/CFₓ (x=0.76) coin cell was made with the same components as described above except the positive electrode was 85% CFₓ powder, 8% PVDF, and 7% carbon black. The cell was discharged at 4 mA/cm² to a cut-off voltage of 2.0 V.

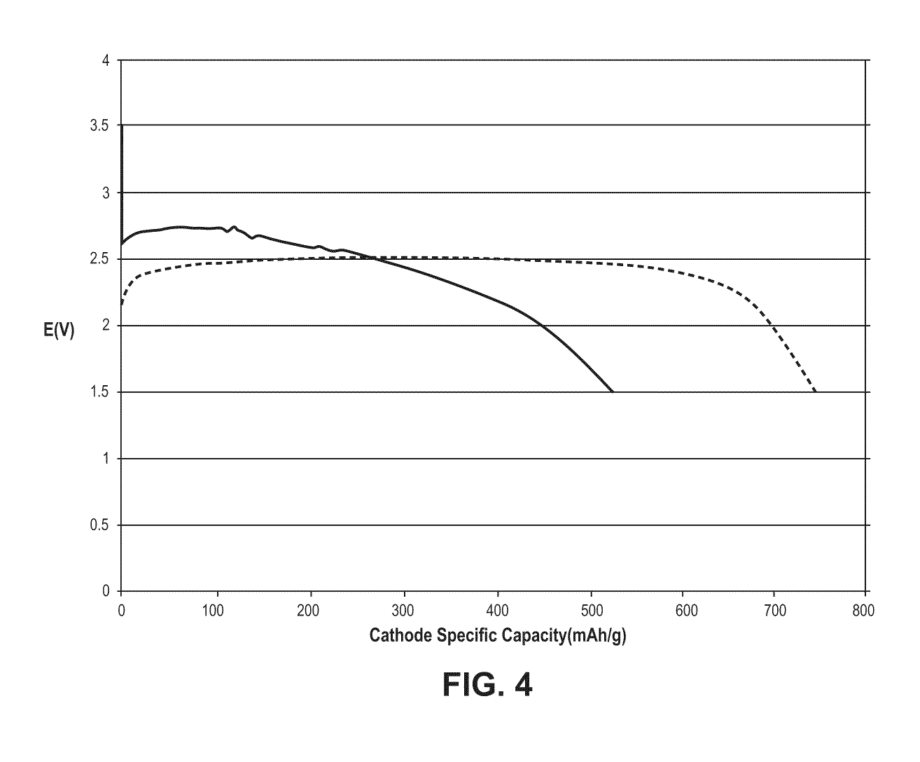

FIG. 4 shows a comparison of the discharge behavior of the Li/CFₓ and Li/CFCFx cells. The cell made with the fluorinated carbon-carbon composite cathode delivered a discharge capacity which is over 90% of cathode theoretical capacity whereas that made with the fluorinated carbon powder delivered a discharge capacity of only 67% of cathode theoretical capacity.

A preferred form of Li/CFCFₓ cell embodying a fluorinated carbon-carbon composite cathode is shown in FIG. 5. Wherein the assembled cell is shown with the anode, cathode, separator, and electrolyte enclosed in a coin cell structure. The anode and cathode of the assembled cell are separated by a porous separator that is permeated with a non-aqueous electrolyte (not shown) that is in effective contact with both the anode and cathode.

1. An electrode material comprising a carbon-carbon composite having a carbon fluorination level between about CF_{0.3} and CF_{0.99}.

2. The electrode material of claim 1, wherein the carbon-carbon has a carbon fluorination level between about CF_{0.6} and CF_{0.85}.

3. The electrode material of claim 1, further comprising a carbon-carbon composite having CF to form a CFCFₓ composite.

4. The electrode material of claim 1, wherein the carbon-carbon composite is made from a carbon fiber.

5. The electrode material of claim 1, wherein the carbon-carbon composite does not include substantial amounts of electrical diluents.

6. The electrode material of claim 1, wherein the carbon-carbon composite does not include substantial amounts of binders.

7. A method for manufacturing an electrode material, comprising the steps of providing a carbon-carbon composite, and sub-fluorinating the carbon composite to yield an electrode material having a carbon fluorination level between about CF_{0.3} and CF_{0.99}.

8. The method of claim 7, wherein the carbon-carbon composite is made from a carbon fiber.

9. The electrode material of claim 7, wherein substantial amounts of electrical diluents are not added to the carbon-carbon composite.

10. The electrode material of claim 7, wherein substantial amounts of binders are not added to the carbon-carbon composite.

11. The electrode material of claim 7, further comprising the steps of sub-fluorinating a sheet of carbon-carbon composite, and then cutting the sub-fluorinated sheet into portions for insertion into an electrochemical cell.

12. An electrochemical cell comprising
a non-aqueous electrolyte,
a first electrode in effective contact with the non-aqueous electrolyte, and
a second electrode in effective contact with the non-aqueous electrolyte, the second electrode comprising a subfluorinated carbon-carbon composite.

13. The electrochemical cell of claim 12, wherein the first electrode further comprises an alkali metal.

14. The electrochemical cell of claim 13, wherein the alkali metal further comprises lithium.

15. The electrochemical cell of claim 12, wherein the second electrode material has a carbon fluorination level between about CF_{0.3} and CF_{0.99}.

16. The electrode material of claim 12, wherein the sub-fluorinated carbon-carbon composite does not include substantial amounts of electrical diluents.

17. The electrode material of claim 12, wherein the subfluorinated carbon-carbon composite does not include substantial amounts of binders.

18. The electrode material of claim 12, wherein the sub-fluorinated carbon-carbon composite is formed from a sub-fluorinated sheet that is cut into portions for insertion into an electrochemical cell.
